(19) United States
(12) Patent Application Publication
(10) Pub. No.: US 2002/0143582 A1
(43) Pub. Date: Oct. 3, 2002

(54) System and method for creating prescriptions

(76) Inventors: Sherry L. Neuman, Galt, CA (US); Erik A. Moore, Foster City, CA (US); Jeffrey T. Smith, San Francisco, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/774,791

(22) Filed: Feb. 1, 2001

(51) Int. Cl. G06F 17/60

(52) U.S. Cl. 705/3; 705/2; 705/4

(57) ABSTRACT

A system and method for creating paper or electronic prescriptions. The system and method permits a user of an electronic prescription creation device to override a drug use evaluation alert, to enter a reason for overriding the drug use evaluation alert, and to enter a reason why a prescribed drug is to be dispensed as written.

### BACKGROUND OF THE INVENTION

1. Field of the Invention

The present invention relates to prescriptions, and, more particularly, to systems and methods for overriding a drug use evaluation alert, for capturing a reason for overriding a drug use evaluation alert, and for capturing and transmitting to a pharmacy a reason why a drug is to dispensed as written.

2. Description of the Related Art

When a patient is in need of medical treatment, a doctor, a nurse, an assistant, a computer, or other entity will diagnose the patient. In many instances, the recommended treatment for the diagnosis requires that the patient take a drug. For many conditions or diseases, it is necessary that a prescriber create a prescription for the patient to obtain the drug needed to treat the diagnosed condition. The prescribed drug may be an over-the-counter drug, i.e., a drug that may be sold without federal or state prescription requirements, or a drug that can only be sold by a pharmacy or dispensed after an order by an appropriately licensed prescriber. The prescriber may be a doctor, an assistant, or other individual licensed to prescribe drugs.

In some instances, the prescriber will prescribe a drug to a patient that may not be the best selection for the particular patient. For example, a patient being treated with warfarin to prevent blood clots may be prescribed a new drug by another specialist to treat arthritis. If taken together, the patient could experience internal bleeding. This complication is generally referred to as a drug-drug interaction because the two drugs interact to produce an adverse result. Besides drug-drug interactions, there are a number of other complications that may result from taking a prescribed medication, such as drug-disease contraindications, drug-allergy interactions, drug-age precautions, drug-gender contraindications, etc. To prevent such complications, it is common for pharmacies, claims processors, and pharmacy benefit managers to perform a drug use evaluation which is a process designed to promote appropriate and effective use of drugs by warning pharmacists and prescribers that potentially harmful events may occur if a specific drug is dispensed as prescribed.

In a typical scenario, a prescriber provides a patient with a prescription for a drug, and the patient later brings the prescription to a pharmacy for fulfillment. The pharmacy enters the prescription into the pharmacist's computer database and performs drug use evaluation to determine if any potential complications exist. If the pharmacist discovers a potential complication, the pharmacist typically telephones the prescriber to notify the prescriber of the drug use evaluation alert. The prescriber may not be aware of the potential complication, and may cancel the prescription or substitute a different drug for the prescribed drug. However, in many instances, the prescriber is already aware of the potential problem created by the prescribed drug and advises the pharmacist to dispense the drug regardless of the drug use evaluation alert. For instance, drug use evaluation conducted by the pharmacist may result in a drug-pregnancy alert, which the prescriber knows is not a concern because the patient is not pregnant and is practicing birth control.

Before dispensing the prescription, however, the pharmacist will forward the prescription to a claims processor or a pharmacy benefit manager, which are entities that will determine, among other things, whether the patient's health insurance provider will pay for all or some of the cost of the prescribed drug. The claims processor or pharmacy benefit management company will also perform drug use evaluation. On occasion, the claims processor's drug use evaluation or the pharmacy benefit management company's drug use evaluation might reveal a potential complication that was not discovered by the pharmacist's drug use evaluation. For example, the patient may have been prescribed a drug by another prescriber that is not of record in the pharmacist's database, but is of record in the claims processor's database or the pharmacy benefit management company's database. Hence, the pharmacist's drug use evaluation might not reveal, for example, a potential drug-drug interaction between two drugs prescribed by different prescribers and filled at different pharmacies. The claims processor or pharmacy benefit management company will advise the pharmacist of the drug use evaluation alert, who then telephones the prescriber to notify the prescriber of the drug use evaluation alert. If the prescriber does not change the prescription, the pharmacist will advise the claims processor or pharmacy benefit management company that the doctor is aware of the drug use evaluation alert. The claims processor or the pharmacy benefit management company then approves the prescription and the pharmacist dispenses the patient's prescription. The claims processor or the pharmacy benefit management company adjudicates the prescription such that the patient's health insurer pays the pharmacy all or some of the cost of the prescription in accordance with the patient's health insurance coverage.

As indicated above, claims processors or pharmacy benefit management companies also determine whether the patient's health insurance provider will pay for all or some of the cost of the prescription. In many instances, the patient's health insurance provider will only pay for prescribed drugs that it approves; these approved drugs are typically referred to as “formulary” drugs. Some health insurance providers, such as MEDICAID, do not have non-formulary drugs such that a prescriber may prescribe practically any drug for a patient, although priori authorization restrictions may apply to some drugs. However, providers such as MEDICAID will typically only pay for the generic form of drugs as available generically as opposed to brand-name drugs, unless the pharmacist submits a reason why the brand-name drug should be dispensed. For example, if a patient covered by MEDICAID is prescribed a generic drug, a claims processor or pharmacy benefit management company will adjudicate the prescription such that the MEDICAID pays the pharmacist for filling the prescription. However, if the patient covered by MEDICAID is prescribed a brand-name drug, the claims processor or pharmacy benefit management company will not adjudicate the prescription unless the pharmacy provides the processor or pharmacy benefit management company a reason why the brand-name drug should be prescribed instead of the generic drug.

There are many instances when pharmacists or prescribers have reasons for prescribing a brand-name drug as opposed to a generic drug. For example, the pharmacists may not have the generic drug in stock or a generic drug is not currently available in the marketplace, in which case MEDICAID will pay the cost of the brand-name drug. Additionally, the prescriber may determine that the brand-name drug is medically necessary, or the patient may request the brand-name drug. In these cases, the prescriber typically writes on the prescription that it is to be “dispensed as written” such that the pharmacist cannot substitute a generic drug for the prescribed brand-name drug as is normally the case. Because the claims processor or the pharmacy benefit management company will not adjudicate the prescription until it is notified of the pharmacist's or the prescriber's reason for prescribing the brand-name drug, if the pharmacist has a reason, the pharmacist communicates it to the claims processor or pharmacy benefit management company and the prescription is adjudicated. But when the pharmacist does not have an apparent reason for prescribing the brand-name drug as opposed to a generic drug and the prescriber has indicated that the drug is to be dispensed as written, the pharmacist typically telephones the prescriber to ask the prescriber's reason for prescribing the brand-name drug. If the prescriber has a reason for prescribing the brand-name drug, the pharmacist communicates this reason to the claims processor or pharmacy benefit management company who then adjudicates the prescription in accordance with the patient's health insurance coverage.

As will be appreciated, these antiquated processes of confirming the prescriber's knowledge of drug use evaluation alerts and obtaining the prescriber's reason for prescribing a brand-name drug, although critically important, are very burdensome for pharmacy benefit management companies, processors, pharmacist, and prescribers.

### SUMMARY OF THE INVENTION

Generally speaking, some embodiments of the present invention strive to simplify the processes of confirming a prescriber's knowledge of drug use evaluation alerts and obtaining a prescriber's reason why a drug is to be dispensed as written.

Other objects, advantages and features associated with the present invention will become more readily apparent to those skilled in the art from the following detailed description. As will be realized, the invention is capable of other and different embodiments, and its several details are capable of modification in various obvious aspects, all without departing from the invention. Accordingly, the drawings and the description are to be regarded as illustrative in nature, and not limitative.

### BRIEF DESCRIPTION OF THE DRAWINGS

FIG. 1 is a schematic of a system according to one embodiment of the present invention.

FIG. 2 illustrates a flow diagram illustrating one embodiment of a method according to the present invention.

FIG. 3 is an example if a patient list display produced on an electronic prescription creation device of the system illustrated in FIG. 1.

FIG. 4 is an example of a drug selection quick list display produced on the electronic prescription creation device of the system illustrated in FIG. 1.

FIG. 5 is an example of a therapeutic category drug selection display produced on the electronic prescription creation device of the system illustrated in FIG. 1.

FIG. 6 is an example of a subcategory drug selection display produced on the electronic prescription creation device of the system illustrated in FIG. 1.

FIG. 7 is an example of a formulary and non-formulary subcategory display produced on the electronic prescription creation device of the system illustrated in FIG. 1.

FIG. 8 is an example of an alphabetic drug selection display produced on the electronic prescription creation device of the system illustrated in FIG. 1.

FIG. 9 is an example of a strength and formulation selection display produced on the electronic prescription creation device of the system illustrated in FIG. 1.

FIG. 10 is an example of a prescription creation display produced on the electronic prescription creation device of the system illustrated in FIG. 1.

FIG. 11 is an example of a dispense as written reason display produced on the electronic prescription creation device of the system illustrated in FIG. 1.

FIG. 12 is an example of a drug evaluation alert display produced on the electronic prescription creation device of the system illustrated in FIG. 1.

FIG. 13 is an example of an override reason display produced on the electronic prescription creation device of the system illustrated in FIG. 1.

FIG. 14 is an example of a finish prescription display produced on the electronic prescription creation device of the system illustrated in FIG. 1.

FIG. 15 is an example of a paper prescription produced with the electronic prescription creation device of the system illustrated in FIG. 1.

### DETAILED DESCRIPTION OF THE PREFERRED EMBODIMENTS

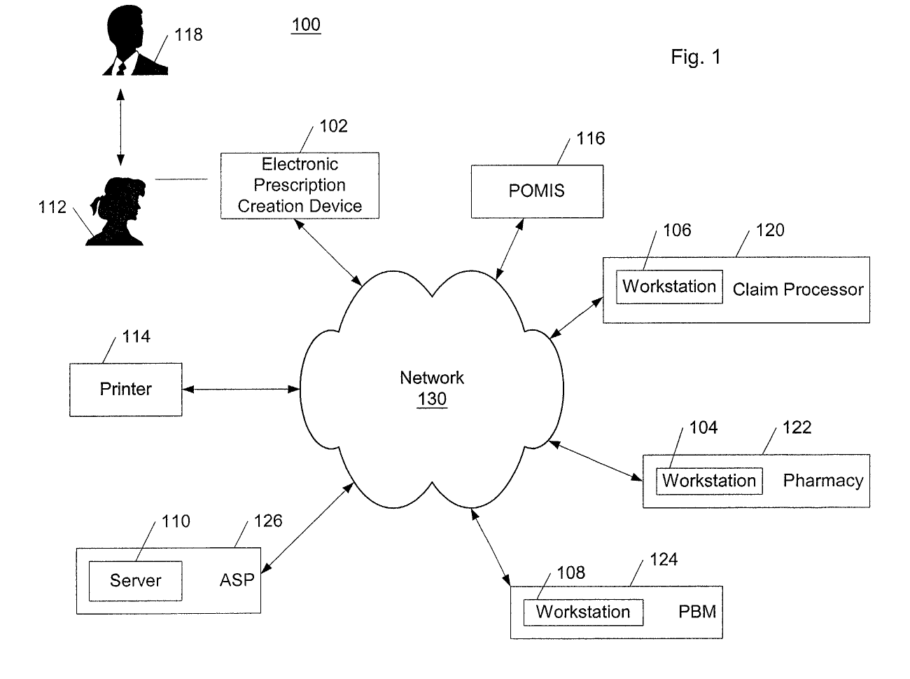

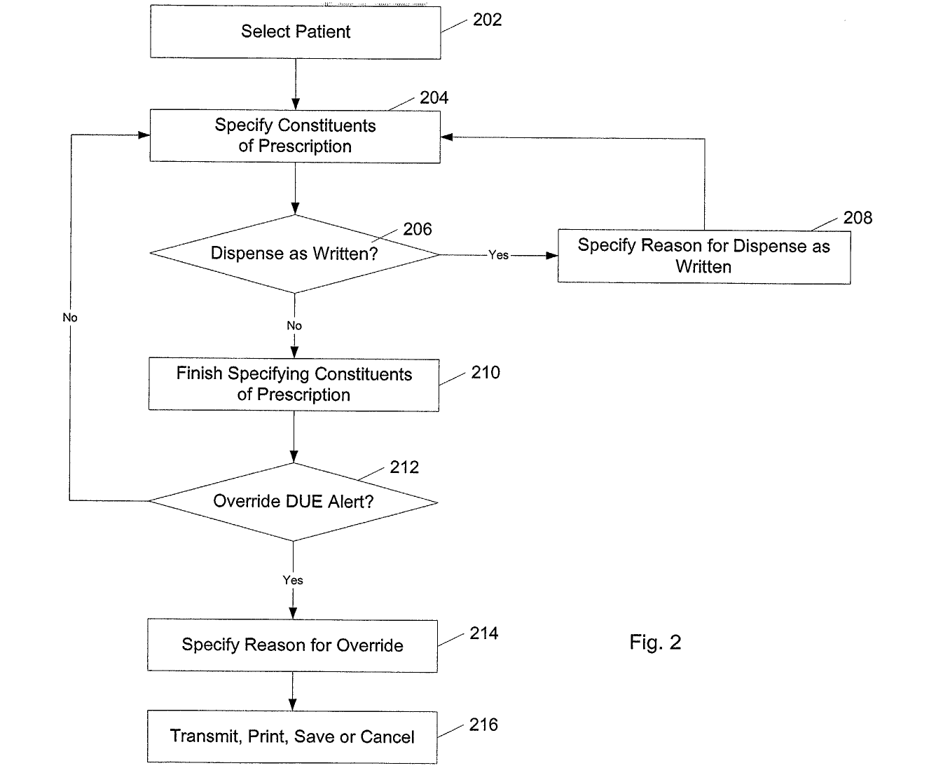

FIG. 1 illustrates one embodiment of a system 100 of the present invention, and FIG. 2 illustrates a flow chart of an exemplary method of the present invention.

As illustrated in FIG. 1, the system 100 includes an electronic prescription creation device 102, a workstation 104 of a pharmacy 122, a workstation 106 of a claims processor 130, a workstation 108 of a pharmacy benefits management company 124 (“PBM”), a server 110 of an application service provider server 126 (“ASP”), a printer 114, a physician office management information system 116 (“POMIS”), and a network 130. As described further below, a prescriber 112 creates prescriptions for a patient 118 with the electronic prescription creation device 102, and the application service provider 126, pharmacy 122, claims processor 130, and/or pharmacy benefit management company 124 utilize information created with the electronic prescription creation device to facilitate the processing of the prescription and other tasks.

The network 130 may be any form of interconnecting network including an intranet, such as a local or wide area network, or an extranet, such as the World Wide Web or the Internet. The network 130 can be physically implemented on a wireless or wired network, on leased or dedicated lines, including a virtual private network (VPN). In the illustrated embodiment, the network is TCP/IP transporting data over secure sockets via user-defined ports. In another embodiment, the system 100 is internet-based and generated in accordance with web-browser and web page data, such as HTML, JavaScript, Java applets, etc. that are transmitted by the server 110 of the application service provider 126. In this alternative embodiment, browser based user interfaces are rendered on the electronic prescription creation device 102 and the workstations 104, 106, 108 in accordance with user interface web page data that is transmitted by the server 110.

The application service provider 126 is any entity that provides software or information for the operation of the electronic prescription creation device 102, workstation 104, workstation 106, workstation 108, and/or the physician office management information system 116. The application service provider 126 may also receive information (such as prescriptions, indications of overrides of drug use evaluations, reasons for overriding drug use evaluation alerts, and reasons for dispensing drugs as written) from the electronic prescription creation device 102, workstation 104, workstation 106, workstation 108, and/or the physician office management system 116 via the network 130. The server 110 of the application service provider 126 is essentially a workstation and may be any storage device for facilitating prescription related tasks, including a plurality of servers, a single server with multiple storage devices, or computers distributed over the network 130. Server 110 may also coexist within one or more of the workstations 104, 106, 108 and the electronic prescription creation device 102. The physician office management information system (“POMIS”) 116 is a system that stores healthcare related information to assist in managing prescriber offices or other medical treatment facilities. Hence, the physician office management information system 116 includes a memory that stores healthcare related information, and preferably includes one or more servers, computers, or other electronic devices capable of receiving and storing healthcare related information. Healthcare related information stored by the physician office management information system 116 may be communicated to the electronic prescription creation device 102 over the network 130 in any known manner and in the manner described in U.S patent application Ser. No. 09/635,876, filed Aug. 10, 2000, the entire disclosure of which is hereby incorporated by reference.

The pharmacy workstation 104, claims processor workstation 106, and pharmacy benefit management company workstation 108 are connected to the server 110 via the network 130. The pharmacy workstation 104, claims processor workstation 106, and pharmacy benefit management company workstation 108 are devices such as personal computers, laptop computers, telephones, wireless phones, personal data assistants (“PDA's”), servers, pagers, and other wireless or hardwired electronic communication devices. The workstations 104, 106, 108 permit the pharmacy 122, claims processor 120, and pharmacy benefit management company 124 to carry out various aspects of processing prescriptions, including receiving electronic prescriptions over the network 130, and in the case of the claims processor and pharmacy benefit management company, adjudicate prescriptions.

The pharmacy 122 is any entity capable of filling prescriptions created by the electronic prescription creation device 102, such as brick & mortar pharmacies, mail-order pharmacies, internet pharmacies, wholesale pharmacies, and other entities who sell prescription drugs, i.e., any prescribed over-the-counter drug or any prescribed medications that can only be sold by a pharmacy or dispensed after an order by an appropriately licensed prescriber. Although one pharmacy 122 is illustrated in FIG. 1, the system 100 may include any number of pharmacies.

The claims processor 120 and the primary benefits management company 124 are entities that adjudicate claims for health insurers. That is, the claims processor 120 and the pharmacy benefit management company 124 contract with health insurance providers such that the pharmacy 122 submits bills for prescriptions to the claims processor 120 and pharmacy benefit management company 124 rather than directly to the health insurer. The processor 120 or pharmacy benefit management company 124 essentially advises the pharmacy 122 if the patient 118's health insurance provider will pay for the prescription such that the pharmacy is assured that it will be paid from the health plan when the pharmacist submits the bill for the prescription to the claims processor or pharmacy benefit management company. Examples of claims processors and pharmacy benefit management companies include Consultech, Unisys, EDS, IBM, Medco, PCS, Expresscript, Advanced Paragon, etc.

As described below, the prescriber 112 will create one or more paper or electronic prescriptions for the patient 118 with the electronic prescription creation device 102. The electronic prescription creation device 102 is a device by which the prescriber 112 can view information about the patient 118 and create an electronic or paper prescription for the patient 118, preferably at the point-of-patient-care (the location where the patient 118 is being diagnosed). The electronic prescription creation device 102 includes a user input/output, which may include a display and a memory, and is configured to run software to view information about the patient 118 and to create prescriptions as described below. The electronic prescription creation device 102 is connected to the server 110 via the network 130, and may, via the network 130, retrieve and transfer information (such as software for carrying out prescription creation activities, as well as other information, such as prescription history, patient demographic information, diagnosis information, drug lists, drug use evaluation alerts, indications of overrides of drug use evaluation alerts, reasons for overriding drug use evaluation alerts, reasons for dispensing a drug as written, etc.) from and to a memory located at the server 110, one or more of the workstations 104, 106, 108, the physician office management system 116, and/or some other location, such as a health maintenance organization (“HMO”).

Suitable implementations of the electronic prescription creation device 102 include devices such as personal computers, workstations, laptop computers, wired or wireless telephones, portable workstations, personal digital assistants (“PDA's”), pagers, and various other electronic devices capable of creating prescriptions. Exemplary electronic prescription creation devices 102 include devices commercially available from suppliers such as iScribe, Inc., Redwood City, Calif., USA. Furthermore, U.S. Pat. Nos. 5,884,273, 5,737,539 and 5,561,446, the entire disclosures of which are hereby incorporated by reference, describe the structure and operation of suitable electronic prescription creation devices. In a preferred embodiment, the electronic prescription creation device 102 is a PDA manufactured by COMPAQ or other Windows CE O/S devices and programmed by the application service provider, iScribe, Inc., Redwood City, Calif., USA.

Alternative embodiments of the system 100 may include more or less of the components illustrated in FIG. 1. For example, the system 100 may only include the network 130, the server 110, and the electronic prescription device 102, which may also be connected to a stand-alone printer to print paper prescriptions. Additionally, the system 100 may include any number of electronic prescription creation devices 102 for use by different prescribers, and any number of different pharmacies 122, claims processors 120, and pharmacy benefit management companies 124.

The operation of one embodiment of the system 100 is now described with reference to FIG. 2. FIG. 2 illustrates a schematic of a method of creating a prescription with the electronic prescription creation device 102 in accordance with one embodiment of the present invention. As described below, the orders of the steps illustrated in FIG. 2 can vary and still be within the confines of the present invention. In addition, it is also contemplated that one or more of the steps illustrated in FIG. 2 may be omitted and still fall within the confines of the present invention.

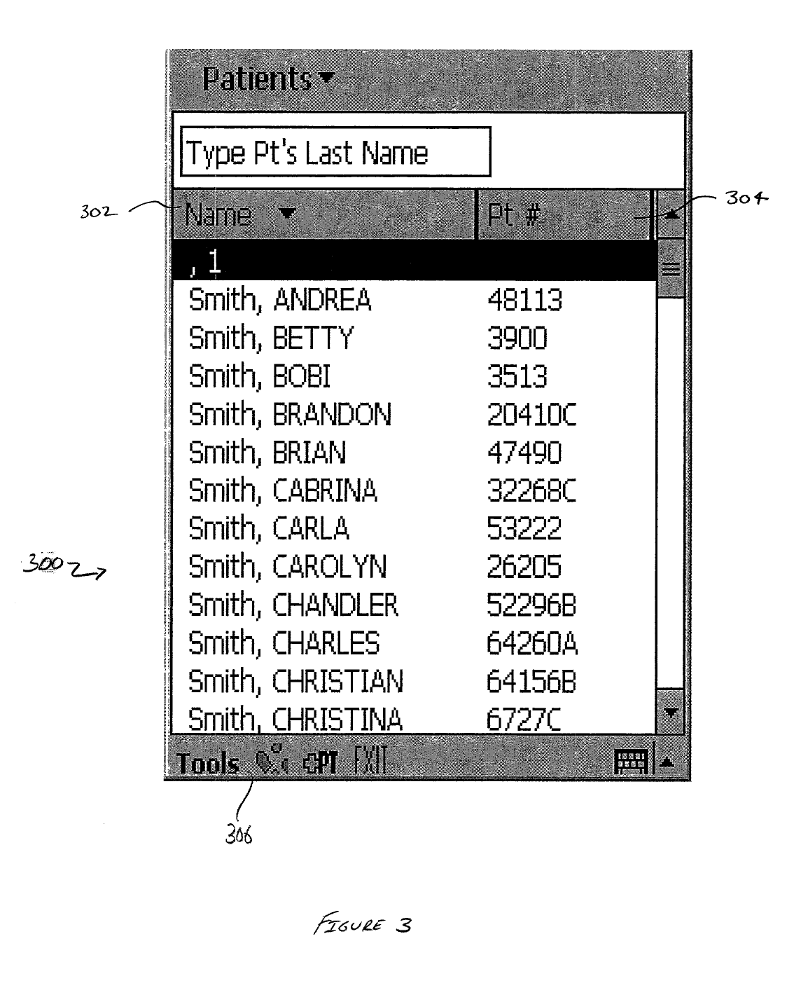

The electronic prescription creation device 102 allows the prescriber to create and view the contents of a prescription via selecting and inputting information through an interactive display, keys, a voice recognition device, or other input mechanism. In a step 202, the prescription creation process begins when the prescriber 112 selects a patient identifier corresponding to the patient 118 from a patient schedule display 300 of the electronic prescription creation device 102, as illustrated in FIG. 3. The patient schedule display 300 includes one or more columns of patient identifiers such as patient numbers and/or patient names. Drop down windows 302, 304 and tool bar 306 allow the prescriber 112 to arrange the healthcare related information in a desired format. For example, the prescriber 112 may choose to view all patients, select patients of a certain age, select patients having a certain ailment, patients to be seen during a certain time frame, etc. By selecting one of the patients listed on the patient schedule display 300, the electronic prescription creation device 102 and/or the server 110 accesses the patient 118's healthcare related information (including prior prescription or medical history of the patient) previously or concurrently retrieved from the physician office management information system 116 or another entity.

After the electronic prescription creation device 102 has retrieved the healthcare related information for the selected patient, at a step 204, the prescriber 112 creates a prescription for the patient 118 by specifying the constituents of the prescription. In the illustrated embodiment, the prescriber 112 first specifies a drug for the prescription. This can be achieved by any one of three options for selecting a drug.

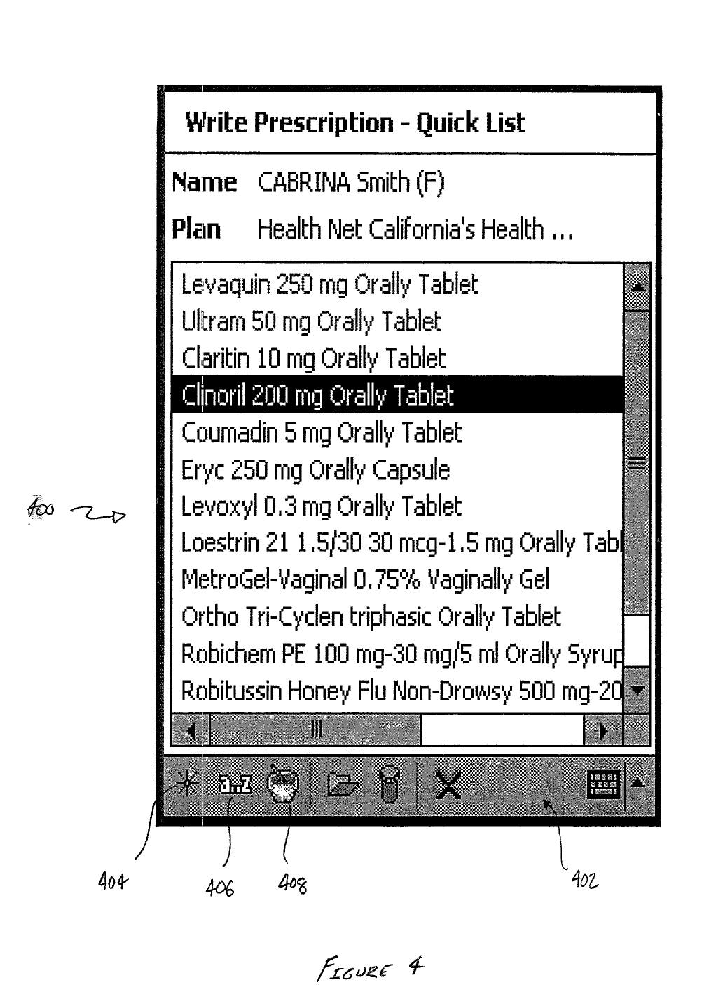

The first option for selecting a drug is a quick list option, to which the electronic prescription device 102 defaults unless instructed otherwise. FIG. 4 illustrates a quick list display 400 of the electronic prescription creation device 102, which includes a list of drugs with dosages and formulations most frequently prescribed by the prescriber 112. For example, FIG. 4 illustrates an example in which the prescriber has selected the drug “Clinoril 200 mg Orally Tablet” from the prescriber's personal quick list of most frequently prescribed drugs. The prescriber 112 may select any of the displayed quick list drugs included in the quick list display 400. As further illustrated in FIG. 4, the display 400 also includes a tool bar 402 displaying a number of icons 404, 406, 408.

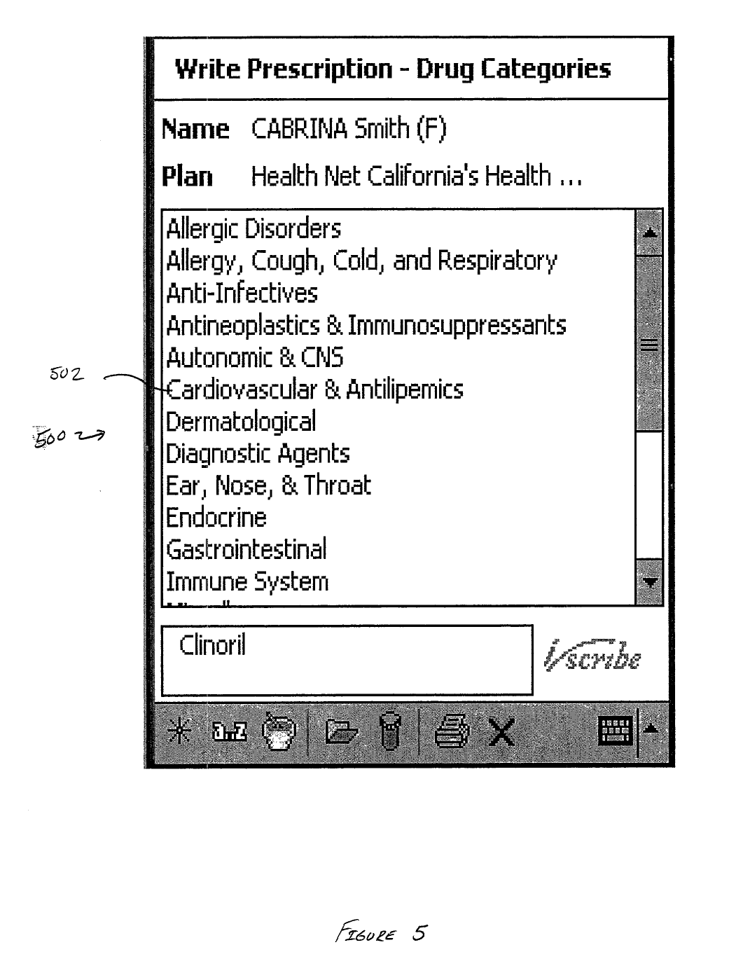

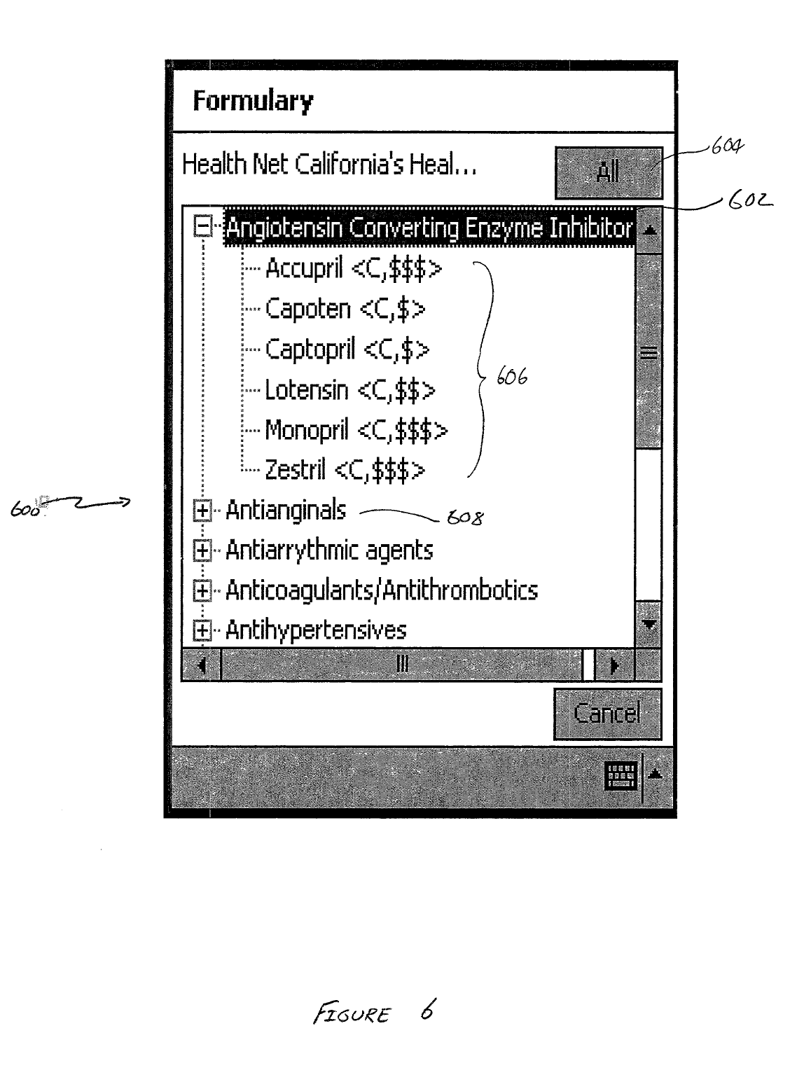

If the prescriber does not desire to prescribe a drug listed on the quick list display 400, the prescriber may select the mortar and pestle icon 408, which will cause the electronic prescription creation device 102 to display a therapeutic category drug selection display 500 illustrated in FIG. 5. The therapeutic category display 500 lists alphabetically arranged therapeutic categories, such as those illustrated in FIG. 5. The therapeutic category display 500 helps the prescriber 112 find a drug to treat a diagnosed condition of the patient 118. For example, if the prescriber 112 determines that the patient needs a drug that is generally prescribed to treat a cardiovascular and antilipemic condition, the prescriber 112 will select the “Cardiovascular & Antilipemics” icon 502 illustrated in FIG. 5. Selecting the “Cardiovascular & Antilipemics” icon 502 will cause the electronic prescription creation device 102 to display the therapeutic subcategory display 600 illustrated in FIG. 6. The therapeutic subcategory display 600 will list subcategories of drugs within the therapeutic category selected by the prescriber 112 at the therapeutic category display 500. For example, because the prescriber 112 has selected the “Cardiovascular & Antilipemics” icon 502, the subcategory display 600 will display icons of subcategories of drugs that fall within the general therapeutic class of cardiovascular and antilipemics, such as the “Angiotensin Converting Enzyme Inhibitor” subcategory icon 602 and the “Antianginals” subcategory icon 608 illustrated in FIG. 6. If the prescriber 112 selects one of the subcategories displayed on the therapeutic sub category display 600, one or more drugs within the selected subcategory will be presented by the electronic prescription creation device 102. In the illustrated embodiment, the prescriber 112 has selected the “Angiotensin Converting Enzyme Inhibitor” subcategory icon 602, which caused the electronic prescription creation device 192 to display a list of drugs 606 (Accupril, Capoten, Captopril, Lotensin, Monopril, Zestril) within the subcategory 602.

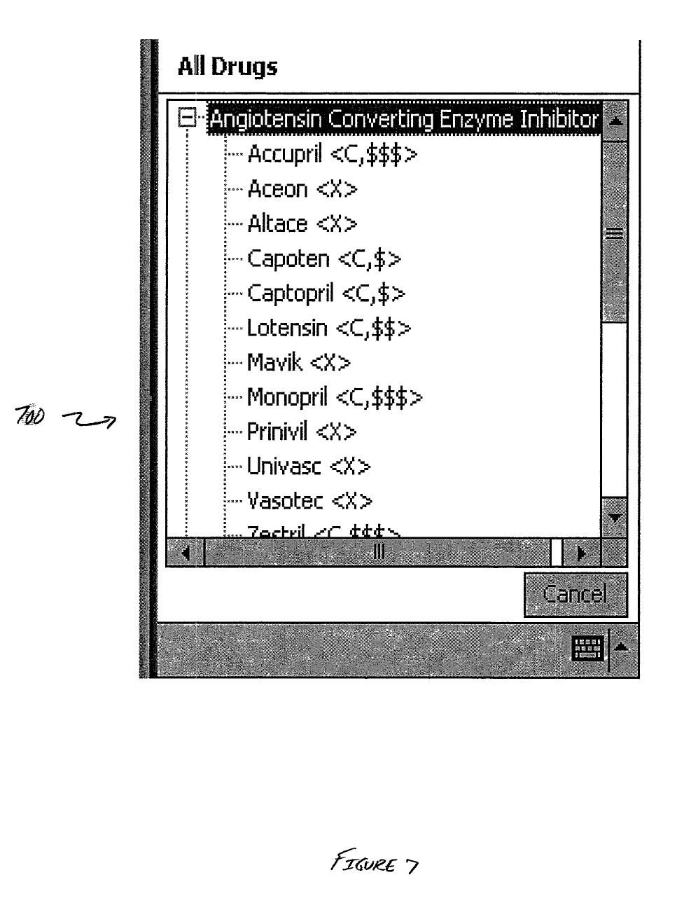

As illustrated in FIG. 6, each of the drugs listed within the subcategory 602 is adjacent a “C” icon as well as one or more dollar sign (“$”) icons. The “C” icon represents that the list of drugs within the subcategory are all covered by the patient 11 8's health insurance plan. The “$” icon is a representation of the relative cost of each drug with respect to each other. In the illustrated embodiment, the electronic prescription creation device will recognize the patient 118's health care insurance plan and only display those drugs in the therapeutic subcategory that are covered by the patient's health insurance plan. “Covered” or “formulary” drugs refers to those drugs that the patient's health insurance provider will pay some or all of the cost for under a patient's health insurance plan. Drugs that the patient's health insurance plan will not pay for are generally referred to as “non-formulary” drugs or drugs that are not “covered.” If the prescriber 112 desires to view all the drugs within the specific sub-category 602, the prescriber will select the “all” icon 604, which will cause the electronic prescription creation device to display both formulary and non-formulary drugs within the specific subcategory 602, as illustrated by the formulary and non-formulary subcategory display 700 illustrated in FIG. 7.

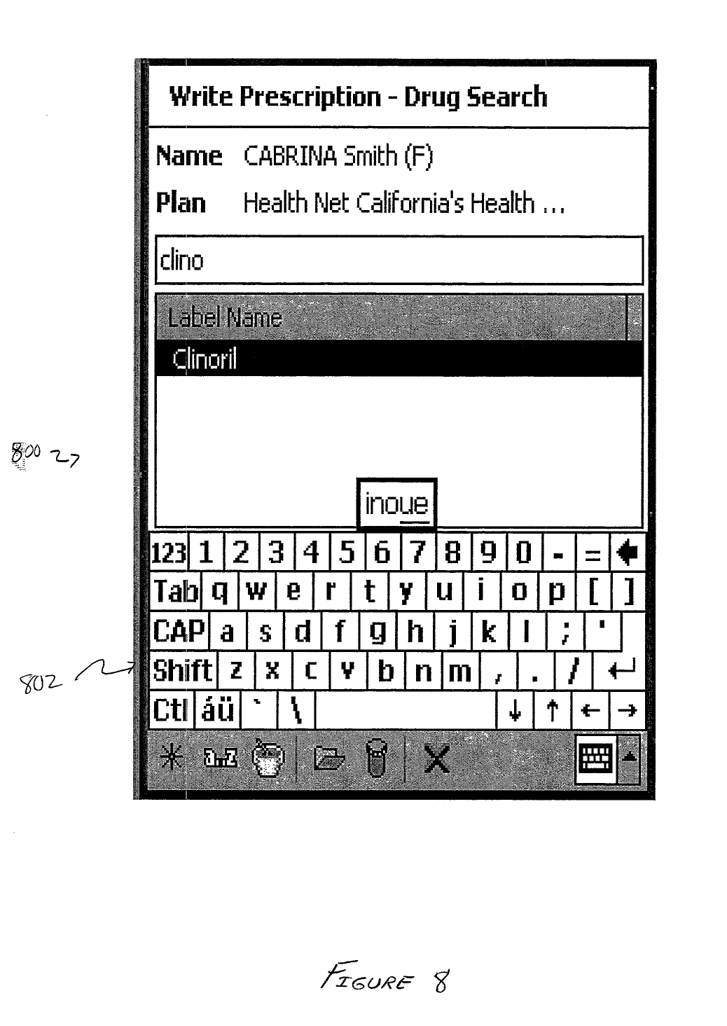

Referring again to FIG. 4, if the prescriber 112 decides not use choose a drug via the quick list option or the therapeutic class option, the prescriber may choose an A-Z drug selection option by selecting the A . . . Z icon 406. When the prescriber selects the A-Z option, the electronic prescription creation device 102 will display the alphabetic drug selection display 800 illustrated in FIG. 8. The alphabetic drug selection display 800 is essentially a feature by which the prescriber can search for a specific drug by name. For example, as illustrated in FIG. 8, the prescriber 112 can enter into the electronic prescription device one or more letters of the desired drug name by using the display keyboard 802 or other entry device. If the prescriber enters the first letter of the drug, such as a “C”, the electronic prescription creation device will display all the prescribable drugs, in alphabetical order, starting with the letter “C”. If the prescriber 112 enters more than one letter, the electronic prescription creation device 102 will search for drugs having the entered order of letters. In the illustrated example, the prescriber has entered “clino”; the electronic prescription creation device 102 searches for a drug with this combination of letters and displays the drug “Clinoril” for selection by the prescriber.

As described above, the prescriber can utilize three display options to select a drug for prescribing: the quick list display 400, the therapeutic category display 500, or the alphabetic drug selection display 800. Each of these avenues permits the prescriber 112 to select a drug for the patient 118's prescription. The prescriber 112 may select a drug displayed on the quick list display 400, the therapeutic category display 500, or the alphabetic drug selection display 800 by using any input device of the electronic prescription creation device 102, including a mouse, a touch screen, a wand, a keyboard, a voice recognition feature, or other input device. The selected drug may be a brand-name or generic drug, depending upon the specific drug selected by the prescriber 112.

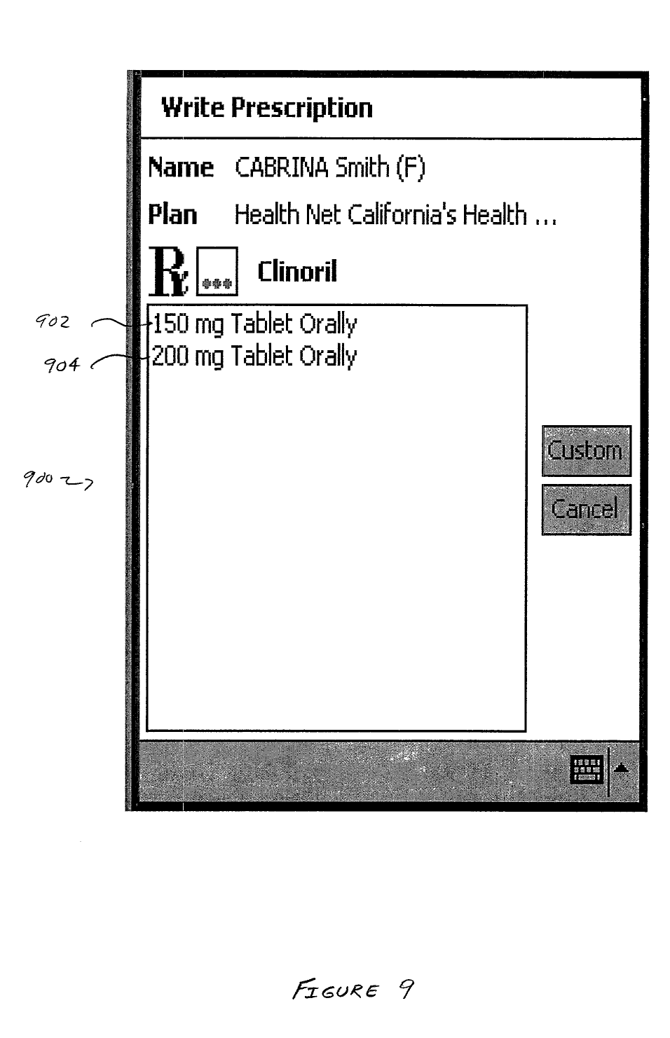

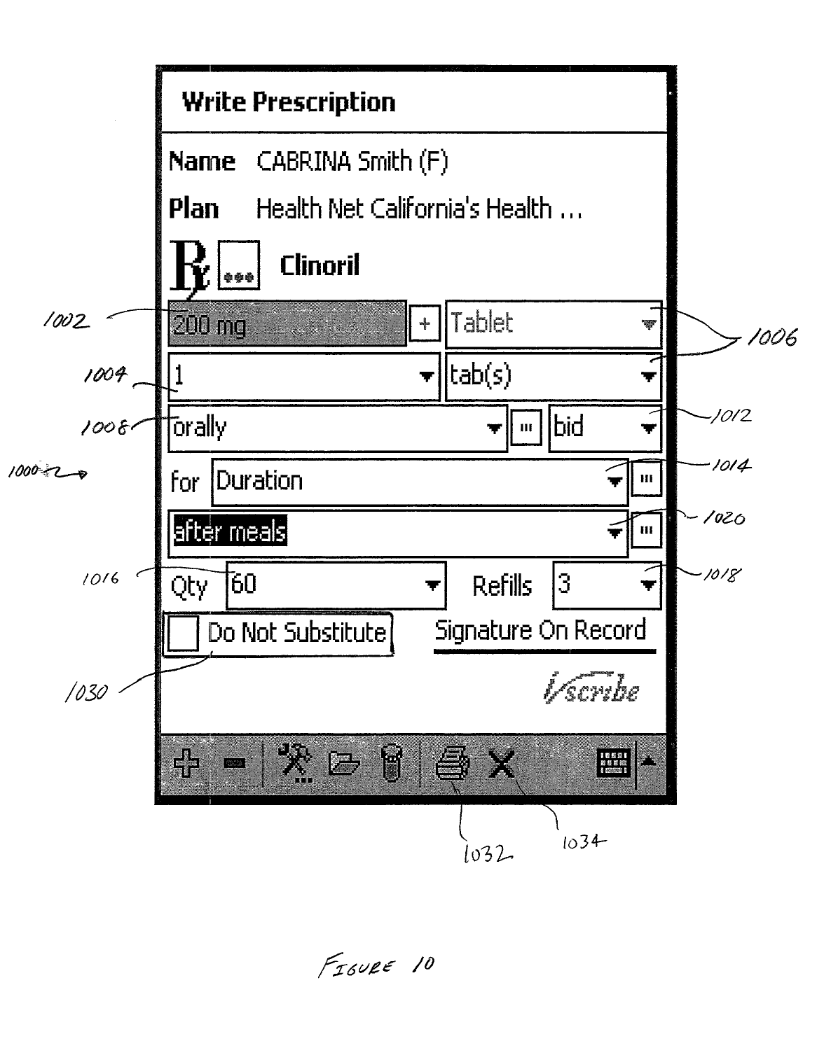

If the prescriber 112 selects a drug via therapeutic category display 500 or via the alphabetic drug selection display 800, the electronic prescription creation device 102 will display a strength and formulation selection display 900 illustrated in FIG. 9. The strength and formulation display 900 will display default strengths and formulations for the drug selected by the prescriber. For example, as illustrated by FIG. 9, if the prescriber 112 selected the drug “Clinoril” via either the therapeutic category display 500 or via the alphabetic drug selection display 800, the strength and formulation selection display 900 will display one or more default strengths and formulation icons 902, 904 for Clinoril. In the illustrated embodiment the default strength and formulations are “150 mg Tablet Orally” and “200 mg Tablet Orally.” If the prescriber 112 selects one of the strength and formulation icons 902, 904, the electronic prescription creation device 102 will present the prescription creation display 1000 illustrated in FIG. 10. If the prescriber 112 selects a drug via the quick list display 400, the electronic prescription creation device 102 will not present the strength and formulation display 900 because the prescribers quick list of drugs already includes strengths and formulation. Hence, if the prescriber 112 selects a drug via the quick list display 400, the electronic prescription creation device 102 will display the prescription creation display 1000, where the prescriber can alter and specify further constituents of the patent 118's prescription as described below.

As illustrated in FIG. 10, the prescription creation display 1000 includes a number of interactive icons 1002, 1004, 1006, 1008, 1012, 1014, 1016, 1018 that permit the prescriber to specify and/or modify the constituents of the patient 118's prescription. The icon 1002 permits the prescriber 112 to specify the strength of the selected drug. The icon 1004 permits the prescriber 112 to specify the dosage or quantity of the selected drug. The icon 1006 permits the prescriber 112 to specify the formulation of the selected drug. The icon 1008 permits the prescriber 112 to specify the route of the selected drug. The icon 1012 permits the prescriber 112 to specify the frequency of administration of the selected drug. The icon 1014 permits the prescriber 112 to specify the duration of the selected drug. The icon 1016 permit the prescriber 112 to specify the dispense quantity of the selected drug. The icon 1018 permits the prescriber 112 to specify the permitted refills of the selected drug. The icon 1020 permits the prescriber 112 to specify any special instructions, such as “take after meals” or “as otherwise directed”. The icons 1002, 1004, 1006, 1008, 1012, 1014, 1016, 1018, 1020 may be pull down menus, text entry areas, links to other prescription creations displays, radio buttons, check boxes, or other graphical features for requesting the entry of information from the prescriber.

As illustrated in FIG. 10, the prescription creation display 1000 also presents the prescriber 112 with a dispense as written query 1030, which is any icon or representation of the graphical user interface of the electronic prescription creation device 102 that requests in any manner whether the selected drug for the patient 118's prescription is to be dispensed as written. When a prescriber instructs that a drug is to be dispensed as written, the prescriber is providing instructions to the pharmacy 122 that fills the prescription not to substitute a generic drug for the brand-name drug prescribed in the prescription. The term “dispense as written” and the term “do not substitute” are known to have the same meaning in the context of prescriptions. In the illustrated embodiment, the dispense as written query 1030 states “□ Do Not Substitute”, which queries whether the prescriber desires to dispense the drug as written. Alternative embodiments may present the dispense as written query 1030 in other forms. For example, the dispense as written query 1030 may state; “□ DAW”; “DAW?”; “□ No Substitutes”; “DNS?” (for “do not substitute”); “Dispense as Written?”; or any other query requesting that the prescriber specify whether the selected drug is to be dispensed as written.

As illustrated in FIG. 10, the dispense as written query 1030 includes an unchecked radio button or check box “□”, which, at a step 206, the prescriber may select to enter via the electronic prescription device an indication that the drug is be dispensed as written. If the prescriber 112 does not check the radio button or check box of the dispense as written query 1030 the pharmacy 112 receiving the completed prescription will presume that it can substitute a generic drug for any prescribed brand-name drug. In alternative embodiments, the prescriber 112 may enter the indication that the drug is to be dispensed as written by keying a command, selecting an icon, a link, an item from a pull down menu, an icon on another display, or by any other interface by which the prescriber can enter an indication that the selected drug is to be dispensed as written.

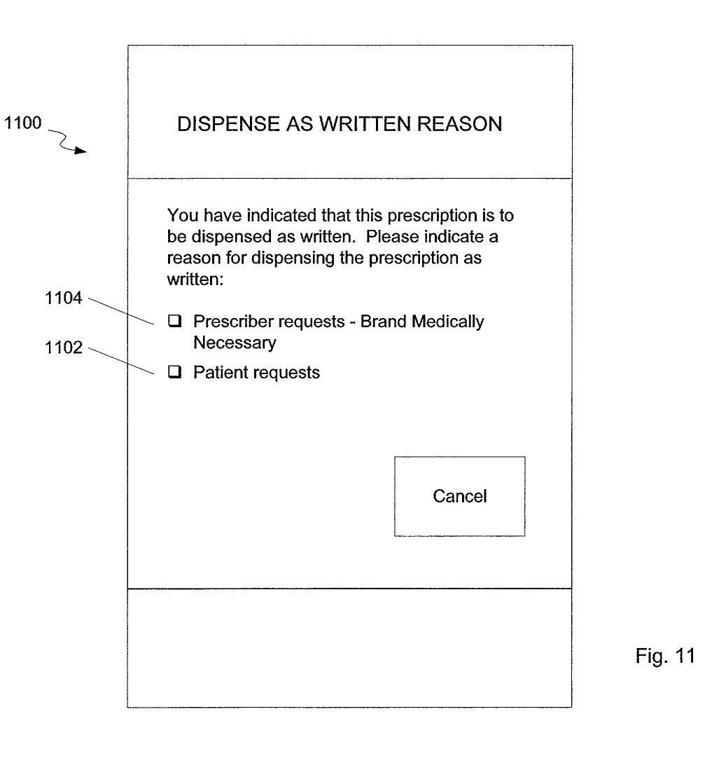

If the prescriber 112 has entered an indication that the selected drug is to be dispensed as written at step 206, then the electronic prescription creation device 102 will present the prescriber with a dispense as written reason display 1100 illustrated in FIG. 11. As illustrated in FIG. 11, the dispense as written reason display 1100 includes a plurality (at least two) of representations 1102, 1104 each corresponding to a motive, i.e., reason, for dispensing the drug as written. In the illustrated embodiment, each of the representations corresponds to a National Council for Prescription Drug Plans (“NCPDP”) dispense as written code as set forth below:

| Representation Number of the | | |
|---|---|---|
| Dispense as Written Reason | | Corresponding NCPDP DAW |
| Display 1100 | Displayed Reason for DAW | Code |
| 1102 | Patient Requests | 2 = Substitution Allowed-Patient |
| | | Requested Product Dispensed - |
| | | This value is used when the |
| | | prescriber has indicated, in a |
| | | manner specified by prevailing |
| | | law, that generic substitution is |
| | | permitted and the patient requests |
| | | the brand product. This situation |
| | | can occur when the prescriber |
| | | writes the prescription using |
| | | either the brand or generic name |
| | | and the product is available from |
| | | multiple sources. |
| 1104 | Prescriber Requests - Brand | 1 = Substitution Not Allowed by |
| | Medically Necessary | Prescriber - This value is used |
| | | when the prescriber indicates, in |
| | | a manner specified by prevailing |
| | | law, that the product is to be |
| | | Dispensed As Written. |

As is apparent, the prescriber 112 may have a number of different reasons for ordering the prescription to be dispensed as written. For example, the prescriber may know that the generic drug is currently unavailable in the market place, or the formulation of the generic drug may not be medically suitable for the patient. In an alternative embodiment, the dispense as written display 1100 includes the NCPDP DAW codes as possible motives or reasons for dispensing the prescription as written.

In a further embodiment of the dispense as written reason display 1100, the electronic prescription creation device presents to the prescriber a list of more specific reasons why the prescriber might specify a brand-name drug to be dispensed as written. For example, the dispense as written reason display 1100 may display the following possible motives or reasons why the prescriber might order a brand-name drug to be dispensed as written: the brand-name is medically necessary to treat the patient's condition, and the patient cannot tolerate the generic formulation.

In the illustrated embodiment, the prescriber 112 enters or specifies, at a step 208, the reason for dispensing the drug as written by selecting one of the representations 1102, 1104. In alternative embodiments, the prescriber 112 may enter the reason for dispensing the drug as written by keying the reason, selecting an icon, a link, an item from a pull-down menu, an icon from another display, or by any other interface by which the prescriber 112 can enter a reason for dispensing the drug as written.

After the prescriber 112 has specified the reason why the drug is to be dispensed as written at step 208, or after the prescriber has indicated that substitutes are permissible at step 206, the electronic prescription creation device 102 will return the prescriber 112 to the prescription creation display 1000. The prescriber 112 can then modify the prescription, cancel the prescription by selecting icon 1034, or, at a step 210, finish specifying the constituents of prescription by selecting icon 1032. After the prescriber has indicated that the constituents of the prescriptions are completed at step 210, the electronic prescription creation device 102, the server 110, or another portion of the system 100 will conduct a drug use evaluation (“DUE”). A drug use evaluation is a process designed to promote appropriate and effective use of drugs by warning prescribers that potentially harmful events may occur if a specific drug is prescribed. In the illustrated embodiment, the drug use evaluation searches for standard complications that are typically performed by pharmacies, processors, and pharmacy benefit management companies. Example of drug use evaluation alerts produced by a drug use evaluation program include one or more of the following:

drug-allergy drug use evaluation alert;

drug-disease drug use evaluation alert;

drug-drug interaction drug use evaluation alert;

drug-food interaction drug use evaluation alert;

overuse drug use evaluation alert;

drug-lab conflict drug use evaluation alert;

high dose drug use evaluation alert;

tobacco use drug use evaluation alert;

ingredient duplication drug use evaluation alert;

excessive quantity drug use evaluation alert;

under-use drug use evaluation alert;

iatrogenic condition drug use evaluation alert;

excessive duration drug use evaluation alert;

low dose drug use evaluation alert;

lactation/nursing interaction drug use evaluation alert;

drug-disease (Reported) drug use evaluation alert;

alcohol conflict drug use evaluation alert;

insufficient quantity drug use evaluation alert;

sub-optimal regimen drug use evaluation alert;

drug-age drug use evaluation alert;

drug-pregnancy drug use evaluation alert;

sub-optimal drug/indication drug use evaluation alert;

sub-optimal dosage form drug use evaluation alert; and

drug-gender drug use evaluation alert.

Appropriate drug utilization evaluations are described in detail in the following papers, each of which is hereby incorporated by reference in its entirety: The Acadamy of Managed Care Pharmacy, Concepts in Managed Care Pharmacy, Drug Use Evaluation (1999); Joint Commission on the Accreditation of Healthcare Organization (1995), Joint Commission on the Accreditation of Healthcare Organizations (1994); Kubacka R T, A Primer on Drug Utilization Review. J Am Pharm Assoc 1996, NS(4):257-61; Palumbo F B, Ober J., Drug Use Evaluation. In: Principles and Practices of Managed Care Pharmacy, Academy of Managed Care Pharmacy, 1995, p. 51-60; Yates W N, Rupp M T, Schondelmeyer S W. A, Drug Utilization Evaluation Primer: Conceptual and Operational Aspects, Proceedings of the Group Health Association of America, Annual Meeting, Jun. 25, 1991; New York; APhA special report. Opportunities for the Community Pharmacist in Managed Care, American Pharmaceutical Association, 1994; American Society of Health System Pharmacists, ASHP Statement on the Pharmacist's Clinical Role in Organized Healthcare Settings, Am J Hosp Pharm 1989, 46:805-6; Academy of Managed Care Pharmacy, Concepts in Managed Care Pharmacy Series—Pharmaceutical Care, 1997; Bowman L., Drug Use Evaluation Is DUE: Healthcare Utilization Evaluation is Over-DUE, Hosp Pharm, 1996, 31:347-53.

Computerized drug use evaluation processes generally fall into two categories: those that require the prescription history or medical history of the patient receiving the prescription and those that utilize a static table of values. Examples of drug use evaluation alerts that generally require the patient's prescription history include: therapeutic duplication; ingredient duplication; drug interactions; drug-disease; drug-pregnancy; drug-allergy; non-compliance (early or late refill) contraindications; lactation/nursing; drug-alcohol; drug-gender; drug-food; drug-lab contraindications; and tobacco use. Examples of drug use evaluation alerts that generally do not require the patient's prescription history or medical history include: high/low dose; excessive duration; suboptimal regimen; suboptimal drug/indication; suboptimal dosage form; iatrogenic condition; insufficient quantity; and drug-age contraindications.

To perform drug use evaluation requiring the patient's prescription history or medical history, the electronic prescription creation device 102, the server 110 or other component of the system 100 recognizes the ingredient and form (tablet, topical cream or ointment, IV or oral solution, etc.) of the drug being prescribed. Each drug that the prescriber 112 may prescribe with the electronic prescription creation device 102 has an indicator for therapeutic class, all drug interactions, and all the contraindications set forth above. When a drug is prescribed, the electronic prescription creation device 102, the server 110 or other component of the system 100 conducts a search to match the indicators of the prescribed drug to the same indicators on each drug in the patient 118's history; if there is a match, a drug use evaluation alert ensues. For example, the conflict may be two drugs within the same therapeutic category, a drug that causes maternal or fetal harm if taken by a pregnant patient, or a drug that is known to cause an allergic reaction in the patient for whom the drug is being prescribed.

To perform drug use evaluation that does not require the patient's prescription history or medical history, the electronic prescription creation device 102, the server 110 or other component of the system 100 calculates values based on the patient demographics and/or the current prescription and reads a table of values representing the appropriate use of the prescribed drug. If the calculated value is over or under the value on the table or if the information on the prescription is different from that on the table, a drug use evaluation alert ensues. For example, each drug that may be prescribed with the electronic prescription creation device 102 has a value for a maximum recommended dose, and if the dose on the prescription is greater than the maximum recommended dose on the table, a high dose drug use evaluation alert is presented to the to the prescriber. Because the maximum recommended dose for MOTRIN is 3200 mg/day or 800 mg four times a day, if the prescription indicates 800 mg every 4 hours (6 times a day), which would equal 4800 mg/day, a high dose drug use evaluation alert is created and displayed to the prescriber 112. As a further example, an excessive duration drug use evaluation alert will occur when antibiotics are prescribed for greater than the usual time frame, e.g., 7 or 10 days, depending on the antibiotic. The electronic prescription creation device 102, the server 110 or other component of the system 100 will read a stored table for the prescribed drug and compare the value on the table to the number of days prescribed; if the prescription value is greater than the table value, an excessive duration drug use evaluation alert is displayed via the electronic prescription creation device 102.

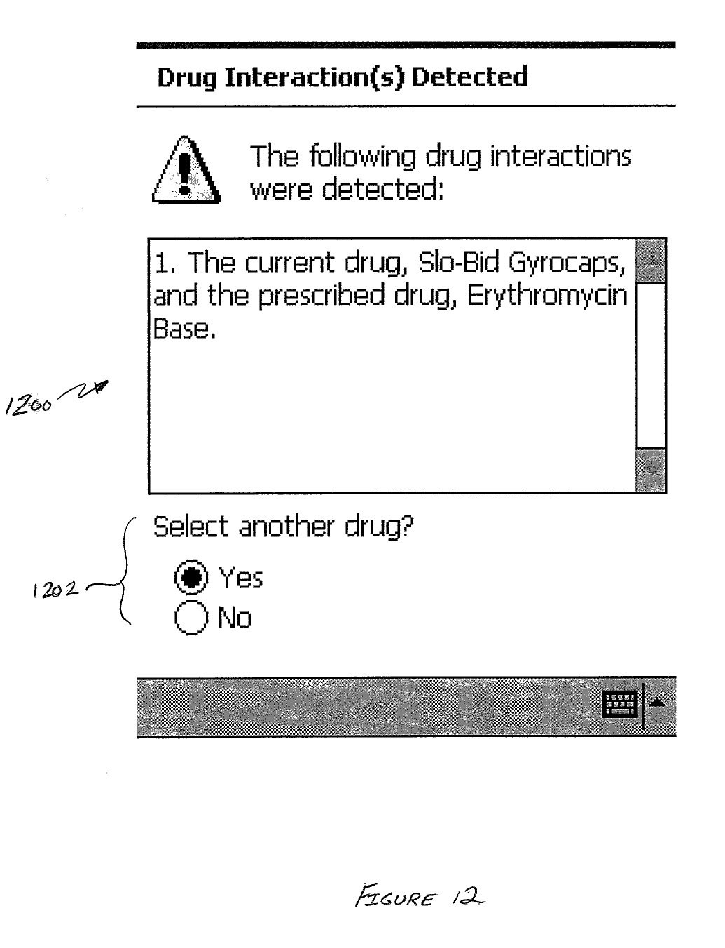

As illustrated by FIG. 12, if a drug use evaluation alert results from the drug use evaluation, the drug use evaluation alert is presented to the prescriber on a drug use evaluation alert display 1200. The drug use evaluation alert display 1200 communicates one more of the above-described drug use evaluation alerts to the prescriber 112. The drug use evaluation alert may be displayed to the prescriber 112 in any variety of manners and may include the specifics of the drug use evaluation alert as illustrated in FIG. 12. The displayed drug use evaluation alert may include text, icons, or other representations that communicate to the prescriber the drug use evaluation alert. Set forth below are drug use evaluation alert abbreviations that may also be used to communicate the drug use evaluation alert to the prescriber.

DA=Drug-Allergy

DC=Drug-Disease (Inferred)

DD=Drug-Drug Interaction

DF=Drug-Food Interaction

ER=Overuse

DL=Drug-Lab Conflict

HD=High Dose

DS=Tobacco Use

ID=Ingredient Duplication

EX=Excessive Quantity

LR=Underuse

IC=Iatrogenic Condition

MX=Excessive Duration

LD=Low Dose

NR=Lactation/Nursing Interaction

MC=Drug-Disease (Reported)

OH=Alcohol Conflict

NS=Insufficient Quantity

SR=Suboptimal Regimen

PA=Drug-Age

TD=Therapeutic Duplication

PG=Drug-Pregnancy

SD=Suboptimal Drug/Indication

SF=Suboptimal Dosage Form

SX=Drug-Gender

As is also illustrated by FIG. 12, the drug use evaluation alert display 1300 includes a drug use evaluation alert override query 1202, which is any icon or representation of the graphical user interface of the electronic prescription creation device 102 that requests in any manner whether the prescriber would like to override the displayed drug use evaluation alert. In the illustrated embodiment, the drug use evaluation override query 1202 states “Select another drug ¤ Yes ¤ No”, which queries whether the prescriber desires to override the drug use evaluation alert presented on the drug use evaluation alert display 1200. Alternative embodiments may present the drug use evaluation override query 1202 in other forms. For example, the drug use evaluation override query 1202 may state: “Override drug use evaluation? □ Yes □ No”; “ODUE? □ Yes □ No”; “Keep the selected prescription? Yes □ No □”; “Override the Drug Use Evaluation Alert? Yes □ No □”; “Prescribe a different Drug? Yes □ No □”; or any other query requesting that the prescriber specify whether the drug use evaluation alert should be overridden, i.e., that the prescription is to be completed regardless of the drug use evaluation alert. As illustrated in FIG. 12, the drug use evaluation alert override query 1202 includes radio buttons “¤ Yes ¤ No”, one of which, at a step 212, the prescriber may select to enter via the electronic prescription creation device 102 an override of the drug use evaluation alert. In alternative embodiments, the prescriber 112 may enter the override of the drug use evaluation alert by keying an override, selecting an icon, a link, an item from a pull down menu, an icon on another display, or by any other interface by which the prescriber can enter an indication that the prescription is to be completed regardless of the drug use evaluation alert. Referring again to FIG. 2, if the prescriber 112 decides not to override the drug use evaluation alert at step 212, the electronic prescription creation device 102 will return the prescriber to the prescription creation display 1000, the quick list display 400, the therapeutic category drug selection display 500, or the alphabetic drug selection display 800, where the prescriber can specify the constituents for a new prescription, including a new drug that might be more appropriate for the patient 118.

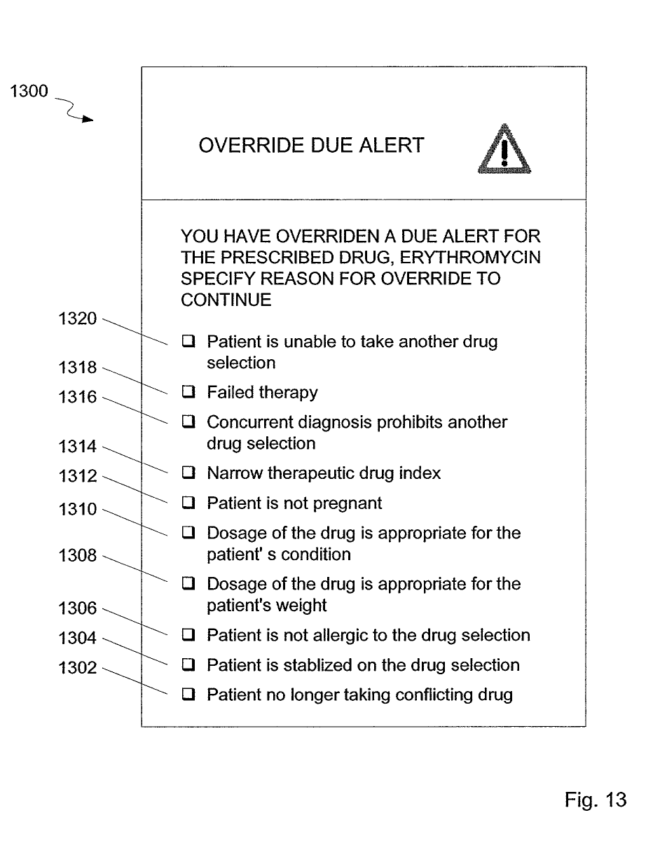

If the prescriber decides to override the drug use evaluation alert at step 212, the electronic prescription creation device 102 will present the prescriber with the override reason display 1300 illustrated in FIG. 13. As illustrated in FIG. 13, the override reason display 1300 presents the prescriber a plurality (two or more) of representations 1302, 1304, 1306, 1308, 1310, 1312, 1314, 1316, 1318, 1320, each corresponding to a motive, i.e., reason, for overriding the drug use evaluation alert. In the illustrated embodiment, the representation 1302 corresponds to an override reason of the “patient is no longer taking a conflicting drug.” The representation 1304 corresponds to an override reason of the “patient is stabilized on the selected drug.” The representation 1306 corresponds to an override reason of the “patient is not allergic to the selected drug.” The representation 1308 corresponds to an override reason of a “dosage of the drug is appropriate for the patient's weight.” The representation 1310 corresponds to an override reason of a “dosage of the drug is appropriate for the patient's condition.” The representation 1312 corresponds to an override reason of the “patient is not pregnant.” The representation 1314 corresponds to an override reason of a “narrow therapeutic drug index.” The representation 1316 corresponds to an override reason of “concurrent diagnosis prohibits another drug selection.” The representation 1318 corresponds to an override reason of “failed therapy.” Lastly, the representation 1320 corresponds to an override reason of “patient is unable to take another drug selection.” The override reason display 1300 may include more representations corresponding to other reasons for overriding the drug use evaluation alert than those illustrated in FIG. 13. For example, the override reason display 1300 may include an override reason for every drug use evaluation alert mentioned above. Likewise, the override reason display 1300 may only include a few common reasons for overriding drug use evaluation alerts. Alternatively, the override reason display 1300 may only include generic categories of override reasons.

As illustrated in FIG. 13, each representation 1302, 1304, 1306, 1308, 1310, 1312, 1314, 1316, 1318, 1320 corresponding to a reason for overriding the drug use evaluation alert includes a radio button or check box “□”, which, at a step 212, the prescriber may select to enter via the electronic prescription device 102 a reason for overriding the drug use evaluation alert. In alternative embodiments, the prescriber may enter the reason for override of the drug use evaluation alert by keying a reason via a keyboard, selecting an icon, a link, an item from a pull down menu, an icon on another display, or by any other interface by which the prescriber can enter an indication of the reason for overriding the drug use evaluation alert.

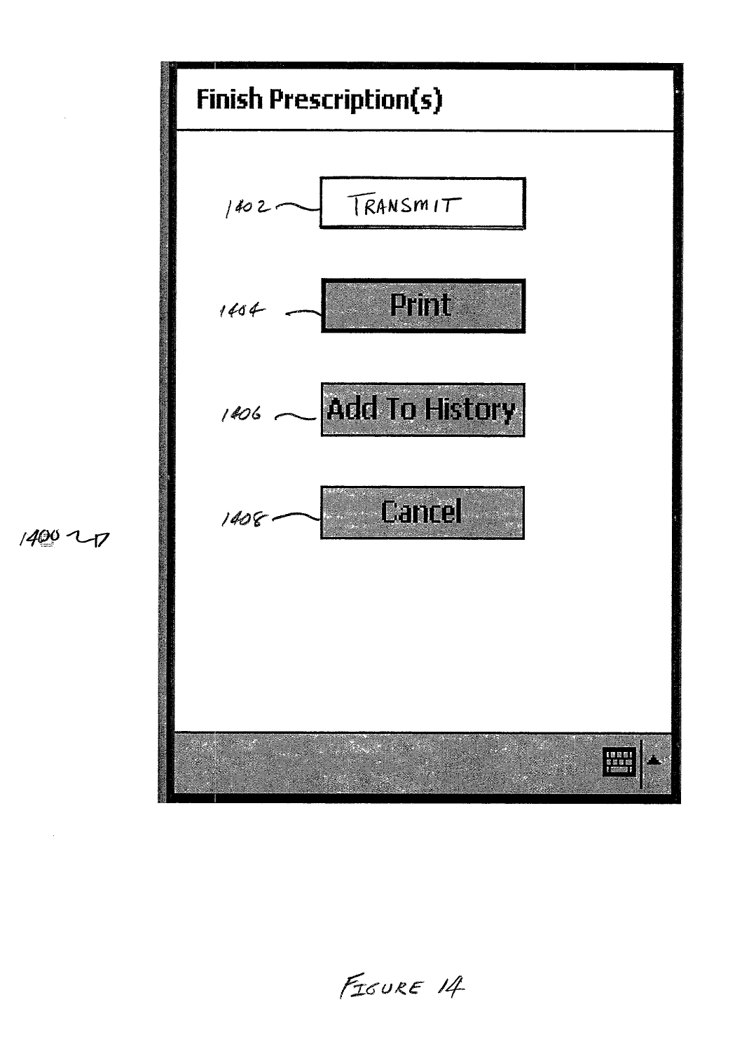

After the prescriber 112 has specified the reason for overriding the drug use evaluation alert, the electronic prescription creation device 102 presents the finish prescription screen 1400 to the prescriber 112. As illustrated in FIG. 14, the finish prescription screen 1400 includes a number of icons 1402, 1404, 1406 that the prescriber may select at a step 216 to complete the prescription. If the prescriber selects the transmit icon 1402, the prescription will be transmitted over the network 130 to the pharmacy workstation 104 of the pharmacy 122. If the prescriber chooses the add to history icon 1406, the patient 118's prescription will be saved in a memory for later transmission or printing. The memory that saves the patient 118's prescription may be in the electronic prescription creation device 102, the server 118, or another memory of the system 100. For example, in one embodiment, one or more created prescriptions are created and saved in the electronic prescription creation device 122, such as in an internal cache, buffer, RAM, or PC card, for later transmission, in individual or batch mode, to the server 118 and/or the workstation 104 of the pharmacy 122 via the network 130. In a further embodiment, the created prescriptions are saved in a patient smart card (a personal card having a memory, such as a magnetic strip or chip) or in a patient's PDA. In one embodiment, the prescriber 112 creates a variety of different prescriptions throughout any given day with the aid of the prescription creation device 102; each of these prescriptions are temporarily saved in the prescription creation device 102 and then transmitted to the server 118 where, as described further below, they are saved for future transmission to the workstation 104 of the pharmacy 122. If the prescriber 112 chooses the print icon 1404, the patient 118's prescription will be printed by the printer 114 such that the patient may immediately receive the paper prescription and bring it to the pharmacy 122 in the traditional manner. Lastly, the prescriber may select the cancel icon 1408 to cancel the prescription.

A prescription created by the electronic prescription creation device 102 may be in electronic form for direct transmission over the network 130 to the workstation 104 of the pharmacy 122, or may be a paper prescription printed from a stand-alone printer or a printer 114 connected to the network 130. A prescription created by the electronic prescription creation device 102 preferably includes among its constituent of elements a patient identifier, a prescription drug identifier, and an identifier of the prescribed drug quantity. The patient identifier may include, but is not limited to, a patient name, a patient social security number, a patient password, a patient health insurance plan identifier, a patient pharmacy benefit identifier, a patient e-mail address, a universal patient identifier, or any other identifier or combination of identifiers distinguishing one particular patient from other patients.

The prescription drug identifier may include, but is not limited to, a drug name, a drug number, a drug code, or other information uniquely identifying the prescribed drug. The embodiments of the present invention apply to the prescription of drugs in general, which include any physiologically or pharmacologically active substance prescribed by a prescriber, including over-the-counter drugs. The prescribed drug may be any of the agents that are known to be delivered to humans or animals, such as medicaments, vitamins, nutrients, or the like. Drugs that may be prescribed in the context of the present invention include drugs that are prescribed to treat any variety of medical conditions. A few examples of prescribed drugs include, but are not limited to, drugs sold under the trade names Allegra, Ceftin, Celebrex, Claritin, Erythromycin, Levaquin, Prinivil, Pravachol, Viagra, Zofran, as well as generic versions of these drugs. The drug may be prescribed alone or in combination with an apparatus, such as a sustained release drug delivery system or other drug delivery apparatus.

The prescription created by the electronic prescription creation device 102 further includes an identifier of the prescribed drug quantity, which is some indication of the amount of drug that the prescriber is prescribing to the patient.

While the paper and electronic prescription created by the electronic prescription creation device 102 at least includes an identifier of the patient, the prescribed drug, and the prescribed drug quantity, the prescription can include other information as well. For example, the prescription may include any of the following information:

patient name;

patient address;

prescriber name;

prescriber address;

prescriber phone number;

DEA number;

date of issuance;

prescribed drug strength;

prescribed drug dosage form (capsule, pill, etc.);

intake method or route of administration (orally, injectable, etc.);

frequency (Q6h, Q8h, monthly, etc.);

directions for use;

number of refills allowed;

permissible substitutes;

license classification;

degree classification;

license number;

diagnosis;

dispense as written indication;

reason for dispensing as written;

drug use evaluation alert;

override of a drug use evaluation alert; and

reason for overriding a drug use evaluation alert.

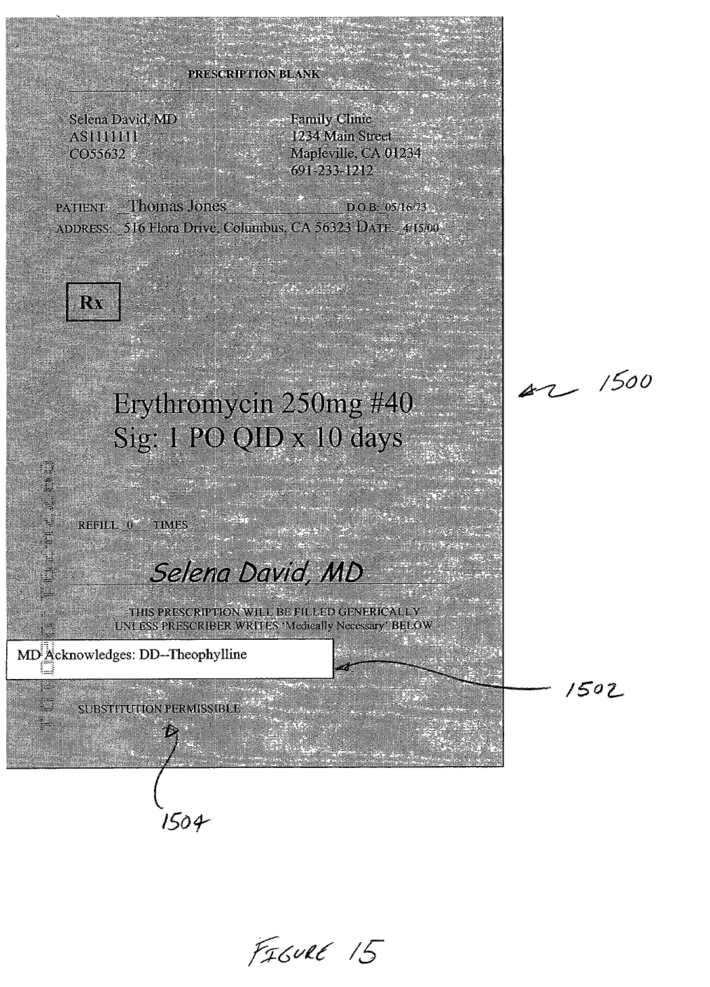

FIG. 15 illustrates one example of a paper prescription 1500 created with the electronic prescription device 102. An exemplary electronic prescription created by the electronic prescription creation device 102 may include information corresponding to that of the paper prescription 1500, as well as that of the various alternative embodiments of the paper prescriptions set forth above and below.

As illustrated in FIG. 15, the paper prescription 1500 includes indicia 1502 communicating that the prescriber 112 has overridden a drug use evaluation alert. In the illustrated example, the indicia 1502 communicates that the prescriber 112 has overridden a drug-drug interaction between erythromycin and theophylline. The indicia 1502 need not communicate the specific drug use evaluation alert; the indicia 1502 may simply communicate that the prescriber 112 has overridden a drug use evaluation alert such as “MD Acknowledges: DD” or “MD Acknowledges DUE Alert”. Alternatively, the indicia 1502 may also include the specified reason for overriding the drug use evaluation alert. For example, the indicia 1502 may read “MD acknowledges: PG drug-pregnancy; Reason for override: Patient not pregnant.” In yet further embodiments, the indicia 1502 may read: “DA acknowledged”; “HD overridden”; “MD Acknowledges DC”; “DA override—failed therapy”.

As is also illustrated in FIG. 15, the paper prescription 1500 further includes indicia 1504 that communicates whether the prescription is to be dispensed as written. In the illustrated example, the indicia 1504 communicates that the prescription is not to be dispense as written such that the prescription may be filled generically. If the prescriber 112 indicated that the prescription is to be dispensed as written in the manner described above, the indicia 1504 would communicate that substitutions are not permitted. Hence, the indicia 1504 would read: “DAW”; “DNS”; “No substitutes permitted”; and/or “Do Not Substitute”. Alternatively, the indicia 1504 may include the specified reason why the drug is to be dispensed as written. For example, the indicia 1504 may read “DAW-patient requests”; “DNS-patient requests”; “Dispense as Written-medically necessary”; “NCPDP DAW Code 1”; or “NCPDP DAW Code 2.”

As will be appreciated, an electronic prescription created with the electronic prescription device 102 may also include the same information as the paper prescription 1500 described above. Hence, the pharmacy 122 receiving the electronic or paper prescription will have knowledge of the prescriber's overriding of the drug use evaluation alert and whether the prescription is to be dispensed as written. In accordance with the alternative embodiment described above, the pharmacy 122 will also have knowledge of the prescriber's reason for overriding the drug use evaluation alert and the prescriber's reason for requesting that the prescription be dispensed as written. Because the pharmacy 122 is aware of the prescriber's reason for overriding the drug use evaluation alert, the pharmacy need not telephone the prescriber to confirm that the prescriber is aware of the drug use evaluation alert obtained from the pharmacy's drug use evaluation. Likewise, if the claims processor 120's drug use evaluation or the pharmacy benefit management company 124's drug use evaluation reveals another drug use evaluation alert, the claims processor, pharmacy benefit management company, and/or the pharmacy need not telephone the prescriber to confirm that the prescriber is aware of the drug use evaluation alert if the paper or electronic prescription already includes the prescriber's acknowledgement or overriding of the subsequent drug use evaluation alert.

Thus, the pharmacy 122 will fulfill the prescription and the claims processor or the pharmacy benefit management 124 company will adjudicate the prescription without having to interrupt the prescriber with telephone confirmations requesting the prescriber's acknowledgement of the DUE alert.

Claims processors or pharmacy benefit management companies also determine whether the patient's health insurance provider will pay for all or some of the cost of the prescription. Some health insurance providers, such as MEDICAID, will typically only pay for generic drugs as opposed to brand-name drugs, unless the pharmacist provides a reason why the brand-name drug should be prescribed. For example, if a patient covered by MEDICAID is prescribed a generic drug, the claims processor 120 or pharmacy benefit management company 124 will adjudicate the prescription such that MEDICAID pays the pharmacy 122 for fulfilling the prescription. However, if the patient covered by MEDICAID is prescribed a brand-name drug, the claims processor 120 or pharmacy benefit management company 124 will not adjudicate the prescription unless the pharmacy 122 provides the claims processor or pharmacy benefit management company a reason why the brand-name drug should be prescribed instead of the generic drug.

As described above, the paper or electronic prescription produced by the electronic prescription creation device may include the reason why the prescriber 112 has specified that the prescription is to be dispensed as written. The claims processor 120 or the pharmacy benefit management company 124 will not adjudicate the prescription until it is notified of the pharmacist's or the prescriber's reason for prescribing the brand-name drug. Because the prescriber 112's reason for prescribing the brand-name drug is included on one embodiment the prescription, such as in the form of a NCPDP DAW code, the pharmacy 122 is immediately aware of the prescriber's dispense as written reason and may communicate this reason to the claims processor 120 or pharmacy benefit management company 124 (by telephone, facsimile, mail, the network 130, or another network), who then adjudicates the prescription in accordance with the patient's health insurance coverage. Thus, the pharmacy 122 will fulfill the prescription and the claims processor 130 or the pharmacy benefit management company 124 will adjudicate the prescription without having to interrupt the practice of the prescriber with a telephone request for a reason for dispensing the drug as written.

As will be appreciated, embodiments of the present invention strive to simplify the processes of confirming a prescriber's knowledge of drug use evaluation alerts and obtaining a prescriber's reason why a drug is to be dispensed as written.

As will also be appreciated, the methods of the invention may include more or less of the steps illustrated in FIG. 2. For example, one embodiment of the prescription creation process illustrated in FIG. 2 does not include capturing the reason the prescriber dispenses a drug as written. Another embodiment does not include capturing an override of a drug use evaluation alert. In yet a further embodiment, the prescription creation process does not include capturing a reason for overriding a drug use evaluation alert. In addition, the order of the steps illustrated in FIG. 2 may vary. For example, the drug use evaluation override may occur before indicating a reason for dispensing a drug as written.

In accordance with a further aspect of the invention, one or more of the following are transmitted to the server 110 of the application service provider 126: the prescriber 112's reason for dispensing drugs as written; the prescriber's overriding of drug use evaluation alerts; and the prescriber's reason for overriding drug use evaluation alerts.

The principles, preferred embodiments, and modes of operation of the present invention have been described in the foregoing description. However, the invention that is intended to be protected is not to be construed as limited to the particular embodiments disclosed. Further, the embodiments described herein are to be regarded as illustrative rather than restrictive. Others may make variations and changes, and equivalents employed, without departing from the spirit of the present invention. Accordingly, it is expressly intended that all such variations, changes and equivalents which fall within the spirit and scope of the present invention as defined in the claims be embraced thereby.

What is claimed is:

1. A method comprising:
entering via an electronic prescription creation device a drug for a prescription;
viewing a drug use evaluation alert on a graphical user interface of the electronic prescription creation device;
viewing on the graphical user interface a query of whether the user desires to override the drug use evaluation alert; and
entering via the electronic prescription creation device an override of the drug use evaluation alert.

2. The method of claim 1, further comprising:
viewing on the graphical user interface a plurality of representations each corresponding to a motive for overriding the drug use evaluation alert.

3. The method of claim 2, the plurality of representations including a representation that a patient is no longer taking a conflicting drug.

4. The method of claim 2, the plurality of representations including a representation that a patient is stabilized on the drug for the prescription.

5. The method of claim 2, the plurality of representations including a representation that a patient is not allergic to the drug for the prescription.

6. The method of claim 2, the plurality of representations including a representation that a dosage of the drug is appropriate for a patient's weight.

7. The method of claim 2, the plurality of representations including a representation that a dosage of the drug is appropriate for a patient's condition.

8. The method of claim 2, the plurality of representations including a representation that a patient is not pregnant.

9. The method of claim 2, further comprising:
selecting via the electronic prescription creation device at least one of the plurality of representations.

10. The method of claim 1, further comprising:
completing the prescription with the electronic prescription creation device.

11. The method of claim 10, the prescription being a paper prescription printed with a printer in communication with the electronic prescription creation device.

12. The method of claim 11, the paper prescription including indicia thereon communicating that the user has overridden the drug use evaluation alert.

13. The method of claim 12, the indicia including the drug use evaluation alert.

14. The method of claim 10, the prescription being an electronic prescription.

15. The method of claim 14, the electronic prescription including information communicating that the user has overridden the drug use evaluation alert.

16. The method of claim 15, the information including the drug use evaluation alert.

17. The method of claim 1, the drug use evaluation alert being at least one of:
a drug-allergy alert;
a drug-disease alert;
a drug-drug interaction alert;
a drug-food interaction alert;
an overuse alert;
a drug-lab conflict alert;
a high dose alert;
a tobacco use alert;
an ingredient duplication alert;
an excessive drug quantity alert;
an under-use alert;
an iatrogenic condition alert;
an excessive duration alert;
a low dose alert;
a lactation/nursing interaction alert;
an alcohol conflict alert;
an insufficient quantity alert;
a sub-optimal regimen alert;
a drug-age alert;
a drug-pregnancy alert;
a sub-optimal drug/indication alert;
a sub-optimal dosage form alert; and
a drug-gender alert.

18. The method of claim 1, further comprising:
entering via the electronic prescription creation device a reason for overriding the drug use evaluation alert.

19. The method of claim 1, the electronic prescription creation device being a personal digital assistant.

20. A method comprising:
entering via an electronic prescription creation device configured to create prescriptions a drug for a patient's prescription;
viewing a drug use evaluation alert on a graphical user interface of the electronic prescription creation device; and entering via the electronic prescription creation device a reason for overriding the drug use evaluation alert.

21. The method of claim 20, further comprising:
viewing on the graphical user interface a plurality of representations each corresponding to a motive for overriding the drug use evaluation alert, the entering via the electronic prescription creation device the reason for overriding the drug use evaluation alert including selecting via the electronic prescription creation device at least one of the plurality of representations.

22. The method of claim 21, the plurality of representations including at least one of the following:
a representation that the patient is no longer taking a conflicting drug
a representation that the patient is stabilized on the drug for the prescription;
a representation that the patient is not allergic to the drug for the prescription;
a representation that a dosage of the drug is appropriate for the patient's weight;
a representation that the dosage of the drug is appropriate for the patient's condition;
a representation that the patient is not pregnant;
a representation of a narrow therapeutic drug index;
a representation that a concurrent diagnosis prohibits another selection;
a representation of a failed therapy; and
a representation that the patient is unable to take another selection.

23. The method of claim 20, further comprising;
completing the prescription with the electronic prescription creation device, the prescription being at least one of a paper prescription and an electronic prescription, the prescription including information communicating the drug use evaluation alert.

24. The method of claim 23, the prescription including an indication that the user has overridden the drug use evaluation alert.

25. A computer-readable medium having instructions stored thereon, the instructions when executed by an electronic prescription creation device cause the electronic prescription creation device to:
create a prescription for a patient;
present on a graphical user interface of the electronic prescription creation device a drug use evaluation alert;
present on the graphical user interface a representation that queries whether the user desires to override the drug use evaluation alert; and
receive from the user a user an override of the drug use evaluation alert.

26. The computer-readable medium of claim 25, the instructions when executed by the electronic prescription creation device further causing the electronic prescription creation device to:
present on the graphical user interface a plurality of motives for overriding the drug use evaluation alert.

27. The computer-readable medium of claim 26, the instructions when executed by the electronic prescription creation device further causing the electronic prescription creation device to:
receive from the user a reason for overriding the drug use evaluation alert, the reason for overriding the drug use evaluation alert being at least one of the plurality of motives presented on the graphical user interface.

28. The computer-readable medium of claim 26, the reason for overriding the drug use evaluation alert being at least one of:
an indication that the patient is no longer taking a conflicting drug;
an indication that the patient is stabilized on the drug for the prescription;
an indication that the patient is not allergic to the drug for the prescription;
an indication that a dosage of the drug is appropriate for the patient's weight;
an indication that the dosage of the drug is appropriate for the patient's condition; and
an indication that the patient is not pregnant;
an indication of a narrow therapeutic drug index;
an indication that a concurrent diagnosis prohibits another selection;
an indication of a failed therapy; and
an indication that the patient is unable to take another selection.

29. The computer-readable medium of claim 25, the instructions when executed by the electronic prescription creation device further causing the electronic prescription creation device to:
include with the prescription an indication that the user has overridden the drug use evaluation alert.

30. The computer-readable medium of claim 29, the instructions when executed by the electronic prescription creation device further causing the electronic prescription creation device to:
include with the prescription the drug use evaluation alert.

31. The computer-readable medium of claim 25, the prescription being an electronic prescription.

32. The computer-readable medium of claim 25, the prescription being a paper prescription.

33. The computer-readable medium of claim 25, the instructions when executed by the electronic prescription creation device further causing the electronic prescription creation device to:
receive from the user a reason for overriding the drug use evaluation alert.

34. The computer-readable medium of claim 33, the instructions when executed by the electronic prescription creation device further causing the electronic prescription creation device to:
communicate to a workstation via a network the reason for overriding the drug use evaluation alert.

35. The computer-readable medium of claim 33, the instructions when executed by the electronic prescription creation device further causing the electronic prescription creation device to:
communicate to a workstation via a network an indication that the user has overridden the drug use evaluation alert.

36. A computer-readable medium having instructions stored thereon, the instructions when executed by an electronic prescription creation device cause the electronic prescription creation device to:
create a prescription for a patient;
present on a graphical user interface of the electronic prescription creation device a plurality of representations each corresponding to a motive for overriding a drug use evaluation alert; and
receive from the user a selection of one of the plurality of representations.

37. The computer-readable medium of claim 36, the instructions when executed by the electronic prescription creation device further causing the electronic prescription creation device to:
communicate to a workstation via a network the selection of one of the plurality of representations.

38. A method comprising:
receiving from an electronic device configured to create prescriptions for patients an indication that a user of the electronic device has overridden a drug use evaluation alert.

39. The method of claim 38, further comprising:
receiving from the electronic device a reason why a user of the electronic device has overridden a drug use evaluation alert.

40. The method of claim 39, the reason being received by a service provider of software for the electronic device.

41. The method of claim 38, further comprising:
receiving a prescription created with the electronic device;
conducting a drug use evaluation for the received prescription to obtain another drug use evaluation alert;
determining whether the user has overridden the another drug use evaluation alert based on the received indication.

42. The method of claim 38, the indication being received by a pharmacy.

43. The method of claim 42, further comprising forwarding the indication to at least one of a pharmacy benefit management company and a claims processor.

44. The method of claim 38, the indication being received by a service provider of software for the electronic device.

45. A computer data signal embodied in a transmission medium comprising:
computer-readable program code for causing an electronic prescription creation device to present a user of the electronic prescription creation device a drug use evaluation alert; and
computer-readable program code for causing the electronic prescription creation device to query whether the user desires to override the drug use evaluation alert; and
computer-readable program code for causing the electronic prescription creation device to receive an override of the drug use evaluation alert.

46. The computer data signal embodied in the transmission medium of claim 45, further comprising:
computer-readable program code for causing the electronic prescription creation device to present a plurality of representations each corresponding to a motive for overriding the drug use evaluation alert.

47. An apparatus comprising:
an electronic device configured to create prescriptions, the electronic device including means for querying whether the user desires to override the drug use evaluation alert, the electronic device including means for receiving an override of the drug use evaluation.

48. The apparatus of claim 47, the electronic device further comprising means for receiving a reason for overriding the drug use evaluation alert.

49. Computer executable software code stored on a computer readable medium of an electronic prescription creation device, the code for generating a graphical user interface, the graphical user interface comprising:
at least one representation querying whether the user desires to override the drug use evaluation alert.

50. The computer executable software code stored on the computer readable medium of the electronic prescription device of claim 49, the graphical user interface further comprising:
at least one representation corresponding to a motive for overriding the drug use evaluation alert.

51. A method comprising:
entering via a an electronic prescription creation device a drug for a prescription of a patient;
viewing on a graphical user interface of the electronic prescription creation device a query of whether the drug is to be dispensed as written; and
entering via the electronic prescription creation device an indication that the drug is to be dispensed as written; and
entering via the electronic prescription creation device a reason why the drug is to be dispensed as written.

52. The method of claim 51, further comprising:
viewing on the graphical user interface a plurality of representations each corresponding to a motive for dispensing the drug as written.

53. The method of claim 51, the entering via the electronic prescription creation device the reason why the drug is to be dispensed as written including selecting one of the plurality of representations.

54. The method of claim 52, the plurality of representations including at least one NCPDP dispense as written code.

55. The method of claim 52, the plurality of representations including a representation that the drug is medically necessary.

56. The method of claim 52, the plurality of representations including a representation that a patient requests the drug.

57. The method of claim 51, the entering via the electronic prescription creation device an indication representing that the that the drug is to be dispensed as written including selecting an icon on the graphical user interface.

58. The method of claim 51, further comprising:
completing the prescription with the electronic prescription creation device.

59. The method of claim 58, the prescription being a paper prescription printed with a printer in communication with the electronic prescription creation device.

60. The method of claim 59, the paper prescription including indicia thereon communicating the reason why the drug is to be dispensed as written.

61. The method of claim 60, the indicia including a NCPDP dispense as written code.

62. The method of claim 58, the prescription being an electronic prescription.

63. The method of claim 62, the electronic prescription including information communicating the reason why the drug is to be dispensed as written.

64. The method of claim 63, the information further communication a NCPDP dispense as written code.

65. A method comprising:
entering via a an electronic prescription creation device a drug for a prescription of a patient;
viewing on a graphical user interface of the electronic prescription creation device a plurality of representations each corresponding to a motive for dispensing the drug as written; and
entering via the electronic prescription creation device a reason why the drug is to be dispensed as written.

66. The method of claim 65, the entering via the electronic prescription device a reason why the drug is to be dispensed as written including selecting at least one of the plurality of representations.

67. The method of claim 65, the plurality of representations including at least:
a representation that the drug is medically necessary; and
a representation that the patient requested the drug.

68. The method of claim 65, further comprising:
completing the prescription with the electronic prescription creation device, the prescription being at least one of a paper prescription and an electronic prescription and including information communicating the reason why the drug is to be dispensed as written.

69. The method of claim 68, the information including at least one NCPDP dispense as written code.

70. The method of claim 67, the plurality of representations include including NCPDP dispense as written codes.

71. A computer-readable medium having instructions stored thereon, the instructions when executed by an electronic device cause the electronic device to:
create a prescription for a drug; and
receive from a user of the electronic device a reason why the drug is to be dispensed as written.

72. The computer-readable medium of claim 71, the instructions when executed by the electronic device further causing the electronic device to:
present on a graphical user interface of the electronic device a plurality of representations each corresponding to a motive for dispensing the drug as written.

73. The computer-readable medium of claim 72, the reason for overriding the drug use evaluation alert being at least one of the plurality of representations presented on the graphical user interface.

74. The computer-readable medium of claim 72, the plurality of representations including at least one of:
a representation that the drug is medically necessary; and
a representation that the patient requested the drug.

75. The computer-readable medium of claim 71, the instructions when executed by the electronic device further causing the electronic device to:
include with the prescription the reason why the drug is to be dispensed as written.

76. The computer-readable medium of claim 75, the prescription being an electronic prescription.

77. The computer-readable medium of claim 75, the prescription being a paper prescription.

78. The computer-readable medium of claim 72, the instructions when executed by the electronic prescription creation device further causing the electronic prescription creation device to:
communicate to a workstation via a network the reason why the drug is to be dispensed as written.

79. A method comprising:
receiving from an electronic device configured to create prescriptions a reason why a drug of a prescription created by the electronic device is to be dispensed as written.

80. The method of claim 79, the reason being received by a service provider of software for the electronic device.

81. The method of claim 79, the reason being received by a pharmacy.

82. The method of claim 81, further comprising forwarding the reason to at least one of a claims processor and a pharmacy benefit management company.

83. The method of claim 79, further comprising receiving the prescription.

84. A computer data signal embodied in a transmission medium comprising:
computer-readable program code for causing the electronic prescription creation device to query whether the user desires to dispense a drug as written; and
computer-readable program code for causing the electronic prescription creation device to receive a reason why the drug is to be dispensed as written.

85. The computer data signal embodied in the transmission medium of claim 84, further comprising:
computer-readable program code for causing the electronic prescription creation device to present a plurality of representations each corresponding to a motive for dispensing the drug as written.

86. An apparatus comprising:
an electronic device configured to create prescriptions, the electronic device including means for receiving a reason why a user of the electronic device requests that a drug for a prescription is to be dispensed as written.

87. The apparatus of claim 86, the electronic device further comprising means for including the reason with a prescription created with the electronic device.

88. Computer executable software code stored on a computer readable medium of an electronic device configured to create prescriptions, the code for generating a graphical user interface, the graphical user interface comprising:
a plurality of representations each corresponding to a motive for dispensing a drug as written, each of the representations being selectable by a user of the electronic device.
